(19) United States
(12) Patent Application Publication
(10) Pub. No.: US 2017/0155328 A1
(43) Pub. Date: Jun. 1, 2017

(54) POWER CONVERTOR

(71) Applicant: Chicony Power Technology Co., Ltd., New Taipei City (TW)

(72) Inventors: Shun-Hsu YANG, New Taipei City (TW); Lyu-Jhih WANG, New Taipei City (TW)

(21) Appl. No.: 15/009,066

(22) Filed: Jan. 28, 2016

(30) Foreign Application Priority Data
Nov. 26, 2015 (TW) 104139506

(51) Int. Cl. H02M 3/335; H02M 1/36

(52) U.S. Cl. CPC H02M 3/33507; H02M 1/36

(57) ABSTRACT

A power convertor includes a transformer, a filtering unit, an isolating unit, a starting unit, a rectifier, an accelerating capacitor, a controlling module and an auxiliary capacitor. The filtering unit is electrically connected to the transformer and the isolating unit. The accelerating capacitor is electrically connected to the rectifier and the isolating unit. The starting unit is electrically connected to the rectifier, the isolating unit, the accelerating capacitor, the controlling module and the auxiliary capacitor. The power convertor is shut down when the controlling module enters a latch mode. The isolating unit is configured to prevent an electric power stored in the filtering unit from entering the starting unit when the controlling module leaves the latch mode. The accelerating capacitor obtains a voltage level and rapidly charges to the auxiliary capacitor to make the power convertor restart when the controlling module leaves the latch mode and resets.

### BACKGROUND OF THE INVENTION

Field of the Invention

The present invention relates to a power apparatus, and especially relates to a power convertor.

Description of the Related Art

As technology grows, electronic products are very important for our daily life. The power sources of the electronic products are mainly the direct current power. However, the wall socket mainly provides the alternating current power. Therefore, the power convertor is usually arranged inside the electronic product to convert the alternating current power into the direct current power to supply power to other components inside the electronic product.

Generally speaking, the power convertor has a latch circuit which can stop the power convertor outputting power when the user operates the electronic product incorrectly. Therefore, the electronic product is protected when the electronic product is operated incorrectly or abnormally.

When the latch circuit of the power convertor is started (namely, when the power convertor enters a latch mode), the electronic product cannot be operated by the input commands from the user. At this time, most of the users will remove the plug of the electronic product from the wall socket, and then will re-plug the plug of the electronic product into the wall socket, so that the latch function provided by the latch circuit is terminated. However, even if the re-plug action mentioned above is executed, the latch circuit cannot terminate the latch function in a short time. This will result that the user thinks that the electronic product having the power convertor is faulted, so that the user may return the electronic product or raise customer complaints.

### SUMMARY OF THE INVENTION

The present invention provides a power convertor comprising a transformer, a filtering unit, an isolating unit, a starting unit, a rectifier, an accelerating capacitor, a controlling module and an auxiliary capacitor. The filtering unit is electrically connected to the transformer. The isolating unit is electrically connected to the filtering unit. The starting unit is electrically connected to the isolating unit. The rectifier is electrically connected to the starting unit and the isolating unit. The accelerating capacitor is connected to the rectifier in parallel. The controlling module is electrically connected to the transformer and the starting unit. A power switch of the power convertor is electrically connected to the transformer and the controlling module. The auxiliary capacitor is electrically connected to the starting unit and the controlling module. The power convertor is shut down (namely, the power convertor stops outputting a power) when the controlling module enters a latch mode. The isolating unit is configured to prevent an electric power stored in the filtering unit from entering the starting unit when the controlling module leaves (namely, terminates or stops) the latch mode. The accelerating capacitor obtains (namely, establishes) a voltage level and rapidly charges to the auxiliary capacitor to make the power convertor restart (namely, to re-output the power) when the controlling module leaves the latch mode and resets.

The starting unit mentioned above can comprise a first starting resistor and a second starting resistor. The first starting resistor is connected to the second starting resistor in series. Moreover, the first starting resistor is electrically connected to the rectifier, the isolating unit and the accelerating capacitor. The second starting resistor is electrically connected to the auxiliary capacitor and the controlling module.

Moreover, the filtering unit mentioned above can comprise two filtering capacitors and a filtering inductor. The filtering inductor can be a common mode inductor. The two filtering capacitors are connected to two sides of the filtering inductor respectively.

Moreover, the transformer mentioned above can comprise a primary winding and an auxiliary winding. The primary winding and the auxiliary winding are coupled to each other. The primary winding is electrically connected to the filtering unit. The auxiliary winding is electrically connected to an auxiliary rectifying component.

In one of the embodiments of the present invention, the power convertor further comprises a breaker, an absorbing circuit and the auxiliary rectifying component. The breaker is electrically connected to the rectifier. The absorbing circuit is connected between the filtering unit and the transformer. The absorbing circuit comprises an absorbing resistor, an absorbing capacitor and an absorbing diode. The absorbing resistor and the absorbing capacitor are connected in parallel. A cathode of the absorbing diode is electrically connected to the absorbing resistor and the absorbing capacitor. An anode of the absorbing diode is electrically connected to the power switch and the transformer. The auxiliary rectifying component is electrically connected to the transformer and the controlling module. The auxiliary rectifying component and the auxiliary capacitor form an auxiliary rectifying unit.

### BRIEF DESCRIPTION OF DRAWING

FIG. 1 shows a block diagram of the power convertor of the present invention.

FIG. 2 shows a circuit diagram of the power convertor of the present invention.

FIG. 3 shows a voltage waveform diagram of the controlling module of the power convertor when resetting.

FIG. 4 shows a voltage waveform diagram of the VB.

FIG. 5 shows a voltage waveform diagram of the Vcc.

### DETAILED DESCRIPTION OF THE INVENTION

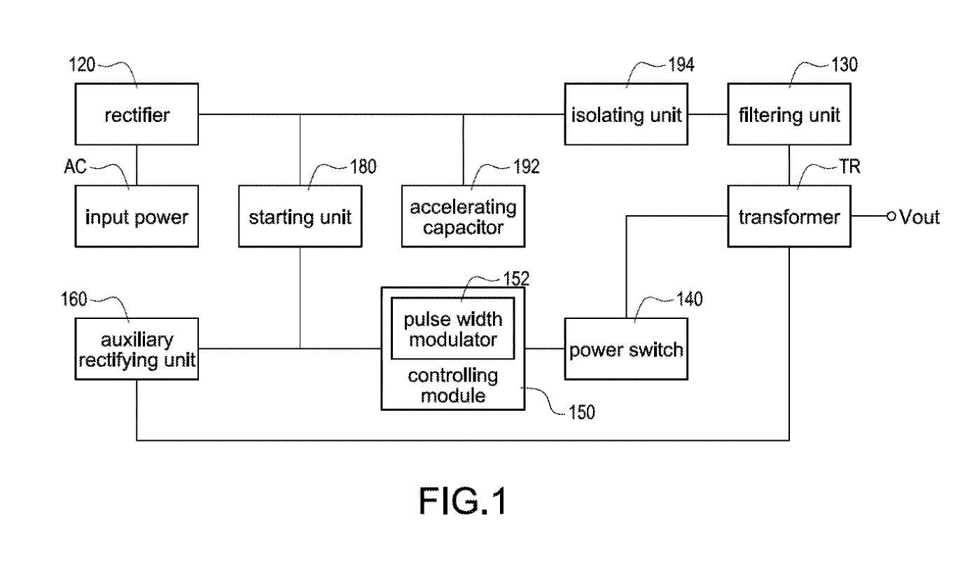

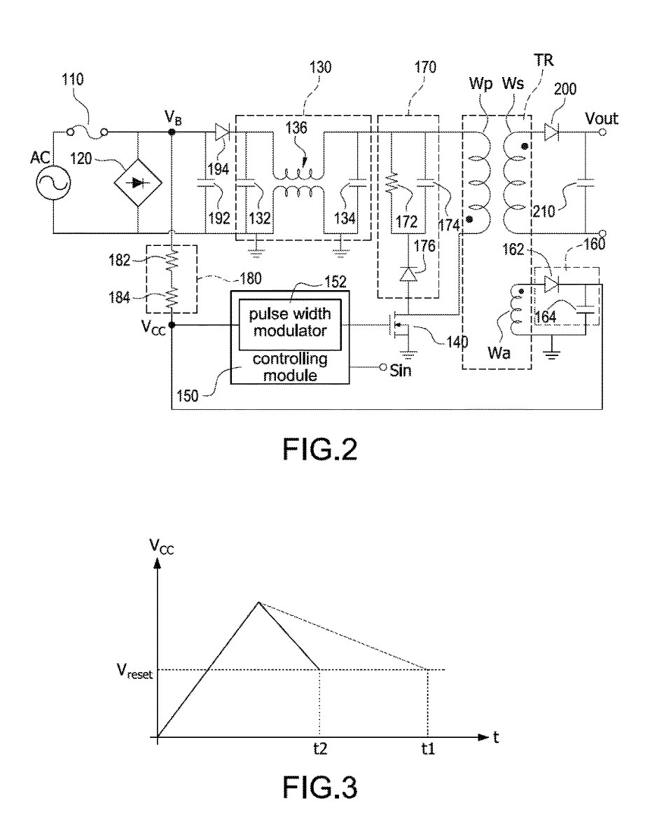

FIG. 1 shows a block diagram of the power convertor of the present invention. FIG. 2 shows a circuit diagram of the power convertor of the present invention. A power convertor is connected between an input power AC and an electronic apparatus (not shown in FIG. 1 or FIG. 2). The power convertor converts an alternating current power provided by the input power AC into a direct current power suitable for the electronic apparatus. The electronic apparatus is connected to an output side Vout of the power convertor. Moreover, the power convertor and the electronic apparatus can be combined as an electronic product (not shown in FIG. 1 or FIG. 2). The electronic product is connected to the input power AC and receives the alternating current power provided by the input power AC. Moreover, the alternating current power received by the electronic product is converted into the direct current power by the power convertor, and then the direct current power is transmitted to the electronic apparatus to execute user input commands.

The power convertor comprises a transformer TR, a breaker 110, a rectifier 120, a filtering unit 130, a power switch 140, a controlling module 150, an auxiliary rectifying unit 160, an absorbing circuit 170, a starting unit 180, an accelerating capacitor 192 and an isolating unit 194.

The transformer TR comprises a primary winding Wp, a secondary winding Ws and an auxiliary winding Wa which are coupled to each other. The output side Vout of the power convertor is electrically connected to the secondary winding Ws through the rectifying diode 200 and the output filter 210. Moreover, an anode of the rectifying diode 200 is connected to the secondary winding Ws. A cathode of the rectifying diode 200 is connected to the output filter 210 and the output side Vout.

The breaker 110 is connected between the input power AC and the rectifier 120. In a normal usage condition, the breaker 110 conducts the input power AC to the rectifier 120, and maintains normal operations of the input power AC and the rectifier 120. If the input power AC generates a surge, the breaker 110 is turned off (namely, not conducted) so that the rectifier 120 is isolated from the input power AC. The breaker 110 can be a fuse or a fused switch. In FIG. 2, the breaker 110 is a fuse.

The rectifier 120 is, for example, a bridge rectifier which is connected between the breaker 110 and the primary winding Wp to rectify the alternating current power provided by the input power AC to generate a pulse direct current power to output.

The filtering unit 130 is connected between the rectifier 120 and the primary winding Wp to restrain an electromagnetic interference and to filter the pulse direct current power. The filtering unit 130 comprises a filtering capacitor 132, a filtering capacitor 134 and a filtering inductor 136. The filtering capacitor 132 and the filtering capacitor 134 are connected to two reverse sides of the filtering inductor 136 respectively. In FIG. 2, the filtering inductor 136 is a common mode inductor. The filtering capacitor 132 is connected between the rectifier 120 and the filtering inductor 136. The filtering capacitor 134 is connected between the filtering inductor 136 and the primary winding Wp.

The power switch 140 is electrically connected to the primary winding Wp. In FIG. 2, the power switch 140 is a metal oxide semiconductor field effect transistor. A drain of the power switch 140 is connected to the primary winding Wp and the absorbing circuit 170. A gate of the power switch 140 is connected to controlling module 150. A source of the power switch 140 is connected to ground.

The controlling module 150 is electrically connected to the auxiliary rectifying unit 160 and the starting unit 180. The controlling module 150 comprises a signal input side Sin and a pulse width modulator 152. The signal input side Sin can be, for example, connected to a microprocessor (not shown in FIG. 1 or FIG. 2) or an abnormal detection circuit (not shown in FIG. 1 or FIG. 2) of the electronic product or the electronic apparatus. When the electronic product or the electronic apparatus is in an abnormal operation, the microprocessor or the abnormal detection circuit mentioned above will send an abnormal signal to the controlling module 150, so that the controlling module 150 enters a latch mode. The pulse width modulator 152 outputs a pulse width modulation signal to the power switch 140, so that the power switch 140 is switched between turned-on and turned-off. Moreover, a level of the power outputted from the output side Vout can be changed by controlling a duty cycle of the pulse width modulation signal.

The auxiliary rectifying unit 160 is electrically connected to the auxiliary winding Wa. The auxiliary rectifying unit 160 comprises an auxiliary rectifying component 162 and an auxiliary capacitor 164. In FIG. 2, the auxiliary rectifying component 162 can be, for example, a diode. An anode of the auxiliary rectifying component 162 is connected to the auxiliary winding Wa. A cathode of the auxiliary rectifying component 162 is connected to the auxiliary capacitor 164, the controlling module 150 and the starting unit 180. The auxiliary winding Wa and the auxiliary rectifying unit 160 provides a required power to the controlling module 150 when operating. A turn ratio of the auxiliary winding Wa can be adjusted according to the required power of the controlling module 150, so that a level of the direct current power outputted by the auxiliary winding Wa is different from a level of the direct current power outputted by the secondary winding Ws.

The starting unit 180 comprises a first starting resistor 182 and a second starting resistor 184. The first starting resistor 182 is connected to the second starting resistor 184 in series. A side (which is not connected to the second starting resistor 184) of the first starting resistor 182 is connected between the rectifier 120 and the filtering unit 130. A side (which is not connected to the first starting resistor 182) of the second starting resistor 184 is connected between the auxiliary rectifying component 162, the auxiliary capacitor 164 and the controlling module 150.

The absorbing circuit 170 is connected between the filtering unit 130, the primary winding Wp and the power switch 140. The absorbing circuit 170 comprises an absorbing resistor 172, an absorbing capacitor 174 and an absorbing diode 176. The absorbing resistor 172 and the absorbing capacitor 174 are connected in parallel. One side of the absorbing resistor 172 and one side of the absorbing capacitor 174 are connected between one side of the filtering unit 130 and one side of the primary winding Wp. The other side of the absorbing resistor 172 and the other side of the absorbing capacitor 174 are connected to a cathode of the absorbing diode 176. An anode of the absorbing diode 176 is connected to the drain of the power switch 140.

The accelerating capacitor 192 and the rectifier 120 are connected in parallel. The isolating unit 194 is electrically connected between the rectifier 120 and the filtering unit 130. In FIG. 2, an anode of the isolating unit 194 is connected to the rectifier 120 and the starting unit 180. A cathode of the isolating unit 194 is connected to the filtering unit 130.

When the electronic apparatus is operated normally (for example, the signal input side Sin of the controlling module 150 does not receive the abnormal signal), the power convertor receives the alternating current power outputted from the input power AC. The alternating current power is processed through the rectifier 120, the filtering unit 130 and the primary winding Wp, and then is coupled to the secondary winding Ws. The rectifying diode 200 rectifies the power which is coupled to the secondary winding Ws to obtain the half-wave direct current power. The output filter 210 filters out the ripple component of the half-wave direct current power, so that the output side Vout outputs the direct current power which is smooth to the electronic apparatus.

When the electronic apparatus is operated abnormally (for example, the signal input side Sin of the controlling module 150 receives the abnormal signal), the controlling module 150 enters the latch mode to stop the output side Vout of the power convertor outputting power to the electronic apparatus to protect the electronic apparatus.

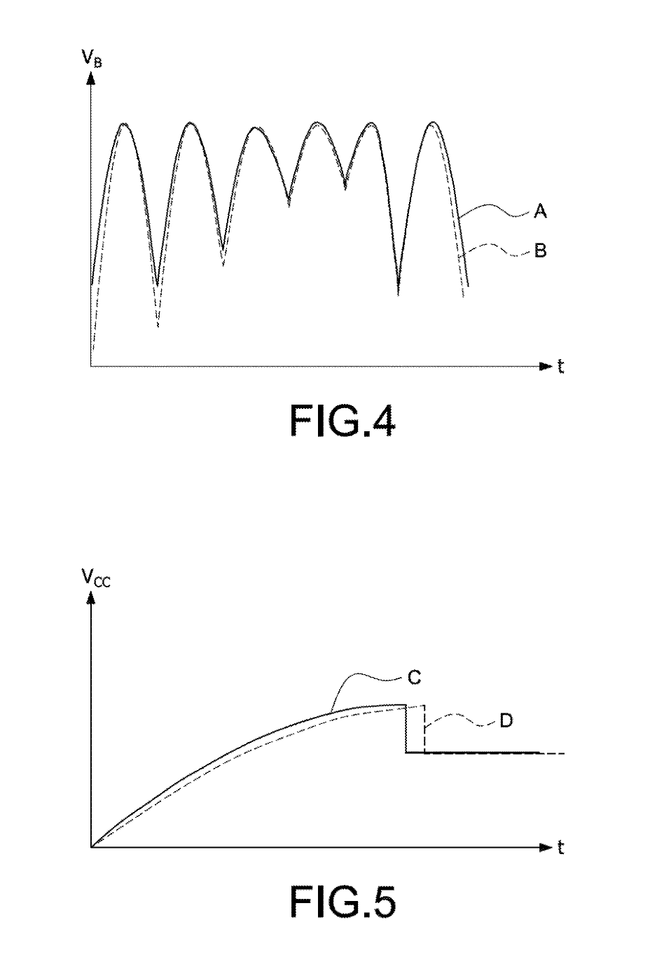

Then, when the controlling module 150 leaves the latch mode (for example, the user removes the plug of the electronic product from the wall socket), the isolating unit 194 is used to avoid the power stored in the filtering unit 130 reversely recharging to the starting unit 180. Moreover, when the controlling module 150 leaves the latch mode and resets (for example, the user re-plugs the plug of the electronic product into the wall socket), the accelerating capacitor 192 obtains (namely, establishes) a voltage level (as shown in FIG. 4 and would be described later) to rapidly charge to the auxiliary capacitor 164 to make the power convertor restart (namely, re-output power).

FIG. 3 shows a voltage waveform diagram of the controlling module of the power convertor when resetting. In FIG. 3, the dash line indicates the power curve of the related art power convertor, the solid line indicates the power curve of the power convertor of the present invention, Vcc indicates the power transmitted to the controlling module 150, Vreset indicates the reset power level of the controlling module 150, and t indicates time. Moreover, after the electronic product is reset, the power of the controlling module 150 has to be lower than the reset power level (namely, the Vreset), so that the controlling module 150 can be reset. In FIG. 3, after the electronic product is reset, the time (t2) that the controlling module 150 of the power convertor of the present invention draws down to the reset status is shorter than the time (t1) that the related art power convertor draws down to the reset status.

FIG. 4 shows a voltage waveform diagram of the VB. A power waveform A shown in FIG. 4 indicates the waveform of the point VB of the power convertor with the accelerating capacitor 192. A power waveform B shown in FIG. 4 indicates the waveform of the point VB of the power convertor without the accelerating capacitor 192. As the power waveform A and the power waveform B shown in FIG. 4, after the electronic product is reset, the voltage of the point VB of the power convertor with the accelerating capacitor 192 is higher than the voltage of the point VB of the power convertor without the accelerating capacitor 192, so that the auxiliary capacitor 164 is rapidly charged. Moreover, FIG. 5 shows a voltage waveform diagram of the Vcc. A power waveform C shown in FIG. 5 indicates the waveform of the point VCC of the power convertor with the accelerating capacitor 192. A power waveform D shown in FIG. 5 indicates the waveform of the point VCC of the power convertor without the accelerating capacitor 192. As shown in FIG. 5, the starting time (the power waveform C) of the controlling module 150 of the power convertor with the accelerating capacitor 192 is shorter than the starting time (the power waveform D) of the controlling module 150 of the power convertor without the accelerating capacitor 192.

After the electronic product is operated abnormally and then is reset, the time that the controlling module 150 draws down to the normal operation is shorter than the time that the related art power convertor draws down to the normal operation, to avoid the user thinking that the electronic product is faulted or the system is faulted, and to avoid the user returning the electronic product or raising customer complaints.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power convertor comprising:
a transformer;
a filtering unit electrically connected to the transformer;
an isolating unit electrically connected to the filtering unit;
a starting unit electrically connected to the isolating unit;
a rectifier electrically connected to the starting unit and the isolating unit;
an accelerating capacitor connected to the rectifier in parallel;
a controlling module electrically connected to the transformer and the starting unit;
a power switch electrically connected to the transformer and the controlling module; and
an auxiliary capacitor electrically connected to the starting unit and the controlling module,
wherein the power convertor stops outputting a power when the controlling module enters a latch mode; the isolating unit is configured to prevent an electric power stored in the filtering unit from entering the starting unit when the controlling module leaves the latch mode; the accelerating capacitor obtains a voltage level and rapidly charges to the auxiliary capacitor to make the power convertor re-output the power when the controlling module leaves the latch mode and resets.

2. The power convertor in claim 1, wherein the starting unit comprises a first starting resistor and a second starting resistor; the first starting resistor is connected to the second starting resistor in series; the first starting resistor is electrically connected to the rectifier, the isolating unit and the accelerating capacitor; the second starting resistor is electrically connected to the auxiliary capacitor and the controlling module.

3. The power convertor in claim 1, wherein the filtering unit comprises two filtering capacitors and a filtering inductor; the two filtering capacitors are connected to two sides of the filtering inductor respectively.

4. The power convertor in claim 3, wherein the filtering inductor is a common mode inductor.

5. The power convertor in claim 1, further comprising a breaker electrically connected to the rectifier.

6. The power convertor in claim 1, further comprising an absorbing circuit electrically connected between the filtering unit and the transformer.

7. The power convertor in claim 6, wherein the absorbing circuit comprises an absorbing resistor, an absorbing capacitor and an absorbing diode; the absorbing resistor and the absorbing capacitor are connected in parallel; a cathode of the absorbing diode is electrically connected to the absorbing resistor and the absorbing capacitor; an anode of the absorbing diode is electrically connected to the power switch and the transformer.

8. The power convertor in claim 1, further comprising an auxiliary rectifying component electrically connected to the transformer and the controlling module, the auxiliary rectifying component and the auxiliary capacitor forming an auxiliary rectifying unit.

9. The power convertor in claim 8, wherein the transformer comprises a primary winding and an auxiliary winding; the primary winding and the auxiliary winding are coupled to each other; the primary winding is electrically connected to the filtering unit; the auxiliary winding is electrically connected to the auxiliary rectifying component.
